(19) United States
(12) Patent Application Publication
(10) Pub. No.: US 2012/0297669 A1
(43) Pub. Date: Nov. 29, 2012

(54) HIGH-EFFICIENCY ENERGY GENERATION USING METALLIC FUELS

(76) Inventor: Harold E. Stockton, JR., Round Rock, TX (US)

(21) Appl. No.: 13/116,917

(22) Filed: May 26, 2011

(51) Int. Cl. C10L 5/36; H01G 4/30

(52) U.S. Cl. 44/530; 361/301.4

(57) ABSTRACT

A fuel pack is constructed of at least two types of stacked plates, a first type and a second type, which may have the same composition. The composition of the first type of plate includes a metal. A plate of the second type is disposed between plates of the first type.

The fuel pack may include two wires, a first wire electrically attached to a first one of the first type of plate; and a second wire electrically attached to a second one of the first type of plate. When the first wire is electrically connected to a positive terminal of a power source and the second wire is electrically connected to a negative terminal of the power source, the plates form a capacitor.

An energy generation system includes a fuel pack receptacle, a preheater, and an ignitor; the ignitor configured to generate a detonation event adjacent a fuel pack.

### BACKGROUND

Energy is generated in many ways, including petrochemical and nuclear energy generation. However, such processes are inefficient and costly. A more efficient and cost-effective way to generate energy is therefore desirable.

Additionally, it is desirable for the energy generation to be scalable such that energy may be generated under a variety of conditions and for a variety of uses.

### FIGURES

FIG. 1 illustrates an exemplary energy generation system.

FIG. 2A illustrates an exemplary fuel pack.

FIG. 2 illustrates another exemplary fuel pack.

FIG. 3A illustrates an exemplary circuit model for a fuel pack.

FIG. 3B illustrates an exemplary equivalent fuel pack circuit model with a preheater.

FIG. 4A illustrates igniting a representative fuel pack.

FIG. 4B illustrates sublimation of a first plate of a representative fuel pack.

FIG. 4C illustrates successive sublimation of plates and dielectric in a representative fuel pack.

FIG. 4D illustrates the progression of sublimation reaching the last plate in a representative fuel pack.

FIG. 5 illustrates waves of particles released during sublimation of a representative fuel pack.

FIG. 6 illustrates an exemplary enclosure including a preheater, an ignitor and a representative fuel pack.

### DETAILED DESCRIPTION

An energy generation system with very high energy yield uses solid metallic fuel. The metallic fuel is sublimated, converted directly from a solid state to a gaseous state. The energy from the sublimation process is harnessed for storage or for immediate use. Fuel packs consumed in the energy generation system include one or more layers of metallic sheets, and may also include a dielectric material between metallic sheets.

To begin the energy generation process, a fuel pack is inserted into the energy generation system. A first metallic sheet in the fuel pack is ignited and subsequently sublimates. The heat and energy from the sublimation of the first metallic sheet causes a next metallic sheet to ignite and then sublimate. As each metallic sheet sublimates it causes a next metallic sheet to ignite until the fuel pack is exhausted. The successive sublimation process generates high levels of energy.

The generated energy may be used directly. For example, the energy may be focused and used as an explosive to shatter rock in a quarry. The energy may alternatively be converted into other forms of energy. For example, the energy may used to rapidly convert water to steam to drive turbines for generating electricity. The energy may alternatively be stored.

The metallic fuel packs provide for high-efficiency and high-productivity energy generation.

FIG. 1 illustrates an exemplary energy generation system 100 shown as a block diagram. Arrows in FIG. 1 indicate no more than the general direction of traverse for signal and energy flow for ease of understanding. System 100 includes a fuel pack receptacle 120, a preheater 130 and ignitor 140 for a fuel pack placed within fuel pack receptacle 120, an energy focus mechanism 150, and an energy sink 160.

Fuel pack receptacle 120 holds one or more fuel packs. Increasing the number of fuel packs used for an energy generation event will increase the amount of energy generated during the event. In some embodiments, receptacle 120 may be constructed to hold only one fuel pack in a particular orientation. In some embodiments, receptacle 120 may be constructed to hold a predetermined number of fuel packs in a particular orientation. In some embodiments, receptacle 120 may be constructed to be adjustable, such that the number of fuel packs may be changed to achieve particular results. A receptacle 120 holding multiple fuel packs may be constructed such that fuel packs are placed side-by-side, are placed end-to-end, or are placed in some other configuration. Receptacle 120 may be further constructed such that fuel pack placement configuration is adjustable.

Fuel pack receptacle 120 may include a mechanism for electrical connection to a fuel pack. In some embodiments, a fuel pack may require electrical signals from receptacle 120, described in detail below. Electrical connection between the fuel pack and receptacle 120 may be through a connector. For example, a fuel pack may include a wire harness with a connector that mates to a connector in receptacle 120. Electrical connection between the fuel pack and receptacle 120 may alternatively be without connector. For example, both the fuel pack and receptacle 120 may have metal pads that touch when the fuel pack is inserted and properly located within receptacle 120.

Fuel pack receptacle 120 is constructed to withstand the high temperature, pressure, and impulse shock resulting from the energy generation process. Receptacle 120 may be designed to channel the energy generated so as to minimize the forces exerted outward from the fuel pack to receptacle 120. Energy generation system 100 may be designed such that receptacle 120 may be easily replaced. For example, receptacle 120 may be replaced after a predefined number of energy generation events, after a predefined amount of fuel has been consumed, after a predefined amount of time, or upon sensor readings indicating stress above a predefined level in the construction or materials of receptacle 120.

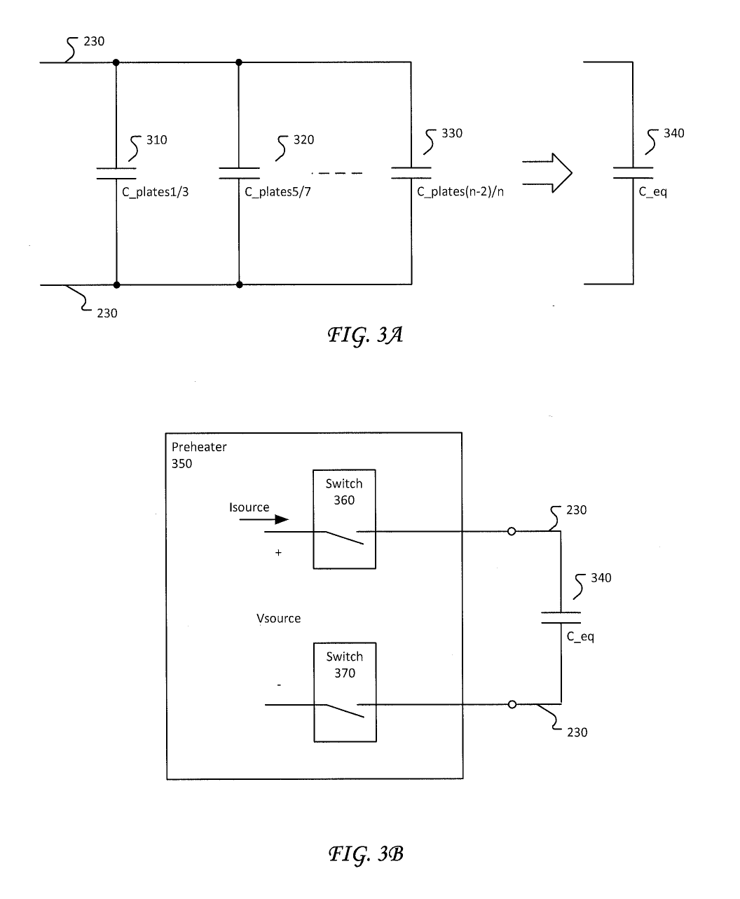

Preheater 130 is optionally included in energy generation system 100 for warming the plates of a fuel pack before ignition. Preheating may increase the amount of energy generated or may decrease the time necessary for complete or nearly complete consumption of the fuel pack. One implementation of a preheater 130 uses electrical current to preheat the plates, as discussed below with respect to FIGS. 3A and 3B.

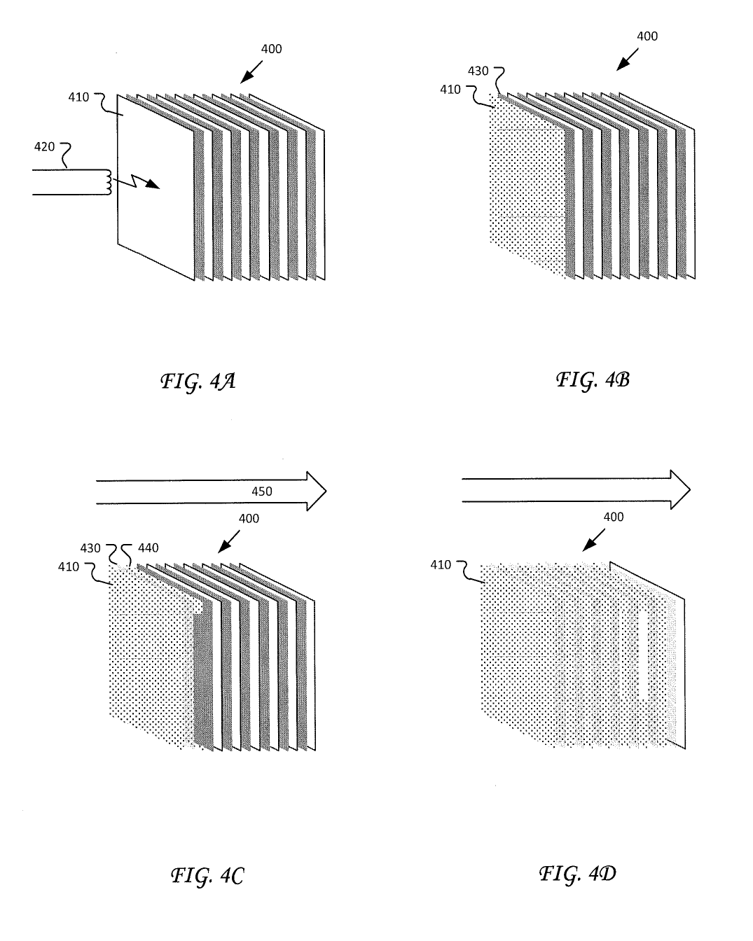

Ignitor 140 generates a spark for igniting the first plate in the fuel pack. One implementation using an ignitor 140 is discussed below with respect to FIG. 4A.

Energy focus mechanism 150 may be included in implementations for which a focused energy output is desirable. For example, it may be advantageous to deliver high energy to a small area for piercing a hard surface such as rock or metal. For another example, it may be desirable to focus the generated energy in order to focus the path of a projectile propelled by the energy.

Energy sink 160 represents the use for the energy, whether the use is direct usage of the energy, is a conversion to other forms of energy, or is storage of the energy.

Energy generation system 100 may include more or fewer components than illustrated in FIG. 1. Additionally, a component illustrated in FIG. 1 may represent multiple instances of the component. For example, energy focus mechanism 150 may include multiple focus mechanisms for generating parallel energy outputs with different focuses, such as different focus distances or focus radii. As another example, multiple fuel pack receptacles 120 may be used, to enable smaller individual fuel packs.

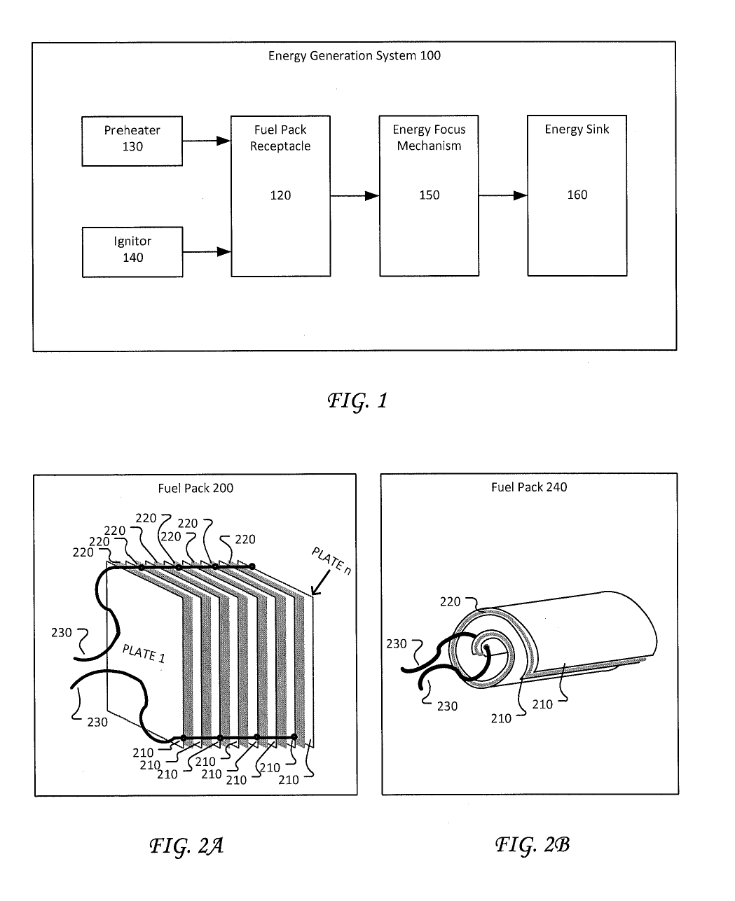

FIGS. 2A and 2B illustrate representative exemplary fuel packs that may be inserted into a fuel pack receptacle 120. FIG. 2A illustrates a stacked generally planar n-plate structure. FIG. 2B illustrates a rolled 3-plate structure. Many other structures are possible, and may include one plate or multiple plates.

FIG. 2A illustrates an exemplary fuel pack 200 constructed of generally planar stacked plates, Plate 1 through Plate n. Plates numbered 210 in exemplary fuel pack 200 are metallic plates. Situated between the metallic plates are optional plates 220 of an alternative material, for example a dielectric or an accelerant. Wires 230 are optional for fuel packs 200 that use electric current preheating. Electric current preheating is discussed in detail below. Wires 230 are attached to every second metallic plate 210. One wire 230 is attached to the first, third, and so on metallic plate 210. The other wire 230 is attached to the second, fourth, and so on metallic plate 210. Wires 230 and plates 210 are electrically connected through the attachment points.

FIG. 2B illustrates an exemplary fuel pack 240, a stacked plate construction in a rolled form. Metallic plates 210 with interspersed alternative material plate 220 are rolled into a cylindrical shape. Optional wires 230 are connected to alternating plates. In FIG. 2B, only two metallic plates are shown, thus one wire 230 is attached to the first plate and one wire 230 is attached to the third (last) plate. Wires 230 and plates 210 are electrically connected through the attachment points.

FIGS. 2A and 2B illustrate just two of the many possible implementations of fuel pack. The implementation of the fuel pack depends on many factors, including the environment in which energy generation system 100 will be used, the energy focus mechanism 150 used if any, the type of energy sink 160, and the availability and cost of materials, to name just a few factors. Additionally, although the plates of FIGS. 2A and 2B are illustrated as square plates, in fact any shape plate may alternatively be used.

Representative fuel pack 200 of FIG. 2A is selected merely by way of example as the basis for the following discussion related to FIGS. 3-6.

FIG. 3A illustrates a circuit diagram that models a fuel pack such as fuel pack 200 of FIG. 2A, for an implementation in which fuel pack 200 includes interspersed plates 220 of a material that acts as a dielectric between metallic plates 210. Capacitor 310 represents a capacitance between the first and third plates, metallic plates 210 with a dielectric plate 220 between. One wire 230 connects to the first plate and the other wire 230 connects to the third plate. Capacitor 320 represents a capacitance between the fifth and seventh plates, metallic plates 210 with a dielectric plate 220 between. One wire 230 connects to the fifth plate and the other wire 230 connects to the seventh plate. In similar fashion, pairs of metallic plates 210 with dielectric 220 between may be represented by a set of parallel capacitors, not shown, with capacitor 330 representing the capacitance between the last two metallic plates 210 with a dielectric plate 220 between.

The parallel capacitances may further be represented by a single capacitor 340 of equivalent capacitance C_eq.

FIG. 3B illustrates a circuit model for a fuel pack electrically connected to an exemplary preheater 350. Switch 360 and switch 370 of preheater 350, when activated, connect a source voltage Vsource or source current Isource to the metallic plates of the fuel pack, represented by equivalent capacitor 340. If the source is a direct current (DC) source, the metallic plates of the fuel pack connected to the positive source terminal charge positively and the metallic plates connected to the negative source terminal charge negatively. If the source is an alternating current (AC) source, each metallic plate alternates between positive and negative charge accordingly. Whether the source is DC or AC, the movement of charge within the metallic plates causes the metallic plates to heat up. Therefore, the metallic plates may be preheated quickly by applying power through wires 230.

In some implementations, the structure of a fuel pack may require wires 230 to be connected with a specific polarity. Other implementations may be polarity-agnostic.

Switches 360 and 370 represent the function of physically connecting the source to the wires 230 of the fuel pack. The illustration of switch 360 and 370 as single-pole single-throw switches is descriptive only and not limiting. For example, a switch 360 or 370 may be a relay, a set of switches, or a relay plus a switch. A switch may be of any type, including a type of silicon-based switch such as a transistor or set of transistors.

Preheater 350 is illustrated in FIG. 3B with a power source switched onto wires 230 of a fuel pack such as fuel pack 200. However, a preheater may be implemented in other ways as well. For example, for a fuel pack constructed without wires 230, a preheater may transfer heat through a physical connection to the metallic plates or through convection of hot air around the metallic plates. As another example, a fuel pack may be immersed in a heated liquid for preheating. In a further example, a fuel pack may be subjected to ultrasonic vibration for preheating via friction between plates of the fuel pack. Other preheating mechanisms may alternatively be used.

Preheating is optional and for some implementations may not be necessary. Preheating may be desirable even if not necessary, for example, to speed up the energy generation process.

Pre-heating by quickly charging the metallic plates of fuel pack with electrical current may provide the additional benefit of ionizing the metallic plates, providing for quicker sublimation of the metallic plates.

FIGS. 4A-4D illustrate the progression of sublimation during the energy generation process of an exemplary flat plate stacked fuel pack. Optional preheating is not shown.

FIG. 4A illustrates a stacked fuel pack 400 of metallic plates interspersed with alternate material plates. A first plate 410 of fuel pack 400 is ignited by ignitor 420 that provides a high-energy discharge to first plate 410.

FIG. 4B illustrates first plate 410 sublimating following detonation by ignitor 420.

As first metallic plate 410 sublimates, the high energy generated by the process of sublimation impacts the face of the first alternative material plate 430 with predominantly incident high-energy force, causing plate 430 to sublimate due to shock compression. The first alternative material plate 430 may include an accelerant to boost the process temperature as it sublimates. The energy from the sublimation of first metallic plate 420 and first alternative material plate 430 then hits second metallic plate 440, causing it to sublimate.

FIG. 4C illustrates first metallic plate 410, first alternative material plate 430, and second metallic plate 440 sublimated. Arrow 450 indicates the progression of fuel plate sublimation and the direction of energy travel. As each plate sublimates, the energy from sublimation of the plate and all previous plates hits the next adjacent plate. The avalanche of sublimation continues until all of the plates of fuel pack 400 are sublimated.

FIG. 4C illustrates the energy wave reaching the last plate of fuel pack 400. When the last plate has sublimated, energy generation is largely completed.

The energy generation process described above uses detonation, and is a hypersonic or supersonic process that propagates through shock compression. The first plate is detonated with an ignitor, and subsequent plates are detonated through shock compression. The supersonic or hypersonic nature of the process results in highly efficient energy generation due in part to the energy from sublimation of a plate being absorbed quickly by the next plate before the energy expands radially out perpendicular to the direction of compression wave travel. However, some energy may expand outwards and may further carry particles from the fuel pack outwards.

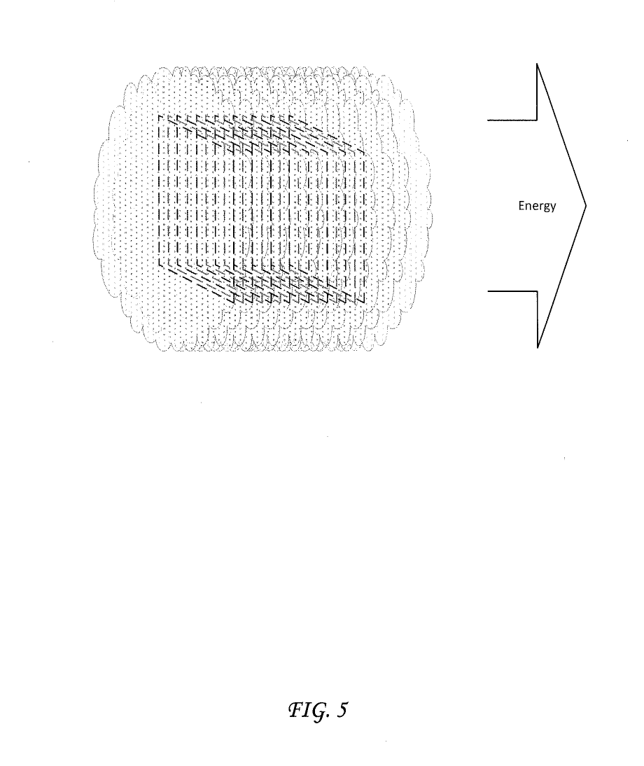

FIG. 5 illustrates the plates of fuel pack 400 fully consumed, shown by dotted lines, leaving clouds of metallic and other particles. A particle cloud may be created each time a plate sublimates. The individual clouds may combine into one or more particle clouds depending on the physics related to the structure and materials of the fuel pack and the fuel pack receptacle. During and after the main energy generation process described above, particles may ignite or detonate and contribute to the energy generated. Thus, energy generation may continue for a time following the total consumption of the fuel pack plates.

The amount of particles left by the process may be reduced by increasing process temperature or pressure. Temperature may be increased by pre-heating, and by including plates with high-temperature sublimation properties within the fuel pack. Pressure may be increased by the geometry of the fuel pack receptacle, such as by using Venturi concepts of volume reduction in the direction of shock wave propagation.

The amount of particles left by the process may be reduced by using plates of increasing mass in the direction of shock wave propagation. In this manner, more of the energy from the sublimation of a plate is absorbed by the adjacent plate of greater mass.

In any energy generation system there are losses. In the energy generation system 100 described above, losses may potentially be attributable to frictional losses, speed losses as the shock wave propagates, energy absorption, energy dispersion, and energy reflection, to name a few. However, the losses will be fractionally small in comparison to the amount of energy produced.

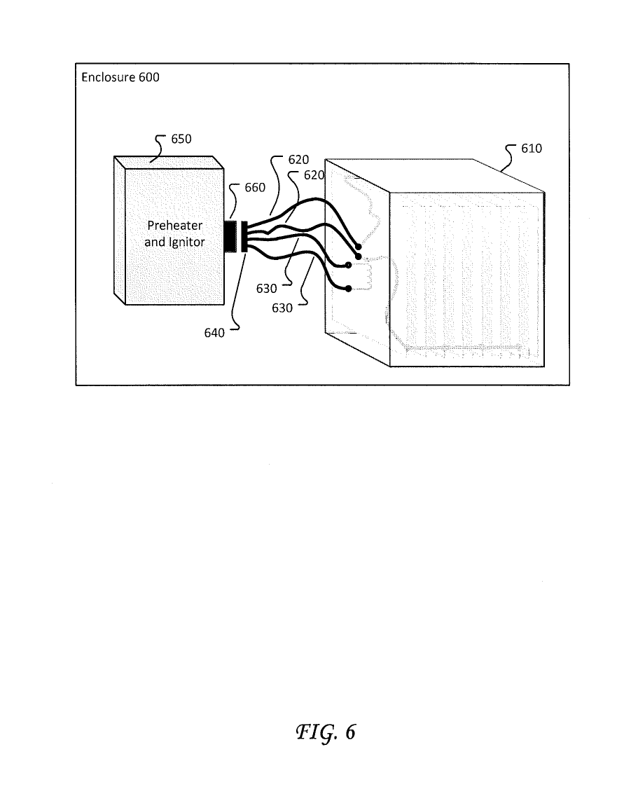

FIG. 6 illustrates an exemplary enclosure 600 of an energy generation system 100. Enclosure 600 includes a cartridge 610 housing an exemplary fuel pack such as fuel pack 200 of FIG. 2A. Wires 620 attach to wires of the fuel pack through the wall of cartridge 610. Wires 630 attach to an ignitor through the wall of cartridge 610. Wires 620 and 630 are terminated in connector 640.

Enclosure 600 further includes a combined preheater/ignitor 650 with a connector 660 that mates to connector 640 of cartridge 610 through the wall of the fuel pack receptacle, not shown.

In FIG. 6, the fuel pack is illustrated as being housed in a cartridge 610. However, in other implementations, the fuel pack has no housing. For example, fuel pack 200 of FIG. 2A may be delivered as a stack of plates with or without wires. For another example, the fuel pack receptacle may be constructed with slots into which plates are placed, such that individual plates are used instead of pre-formed stacks of plates. The option of using individual plates provides great flexibility in the sequence of plates to use, and allows for tuning of the energy process by inserting plates with distinct properties at certain places within the sequence.

Having described the various components that may be included within an energy generation system 100, next are presented several implementations of energy generation systems 100.

### Exemplary Fuel Pack Materials

Metallic plates may be of any size, shape, or thickness Thin-film metal plates may provide for fast sublimation and correspondingly quicker fuel pack consumption. All plates may be thin film. Alternatively, the first plate or plates may be thin-film for initiation of the process, followed by progressively thicker plates. Other combinations of thin and thick plates may be used to generate energy at a controlled speed, pressure, or temperature.

The metallic plates in a fuel pack may be constructed of any pure metal, metal compound, metal alloy, or other combination that includes metal. The composition of the plates may be selected to control for certain properties such as ignition temperature, burn rate, energy yield, and propensity for oxidation. Further, composition of the plates may be selected to achieve an optimized balance of desired properties versus cost.

The metallic plates may be formed of compressed metal particulates, or metal particles compressed with accelerant particles. For example, metal and Teflon (PTFE) particles may be mixed together, compressed, and shaped into fuel pack plates.

A metallic plate may act as a lens to focus energy from the sublimation of an adjacent plate on one side onto the adjacent plate on the other side. Metallic plates may be coated with a material to enhance the lens effect.

Some exemplary elementary materials that may be used in the metallic plates include aluminum, magnesium, and boron. Other metals or metalloids may additionally or alternatively be used.

Aluminum is an attractive metal to use in the metallic plates at least because aluminum is abundant, safe to handle, and is relatively low cost.

Plates made of cupric oxide or other high-boiling point material may be interspersed within the fuel pack to provide an explosive boost, for example to create a boost every twenty-fifth plate or the like. The explosive boost increases the temperature and pressure within the system and contributes to efficiency of the energy generation process. The boiling point of aluminum is approximately 3000 degrees Celcius (3000 C). Some materials with a higher boiling point include Osmium, at 5012 C, Iridium at 4428 C, and Molybdenum at 4639 C.

The alternative material plates, such as plates 220 of FIG. 2A, may be dielectric or accelerant. In some implementations, the material may be both a dielectric and an accelerant.

Dielectrics include paper, cloth, mineral oil, electrets, piezoelectrics, crystals, and polymers, to name just a few.

Accelerants include but are not limited to: Teflon (PTFE, or (CF2-CF2)n); FEP, a copolymer of tetrafluoroethylene and hexafluoropropylene (((CF(CF3)-CF2)x(CF2-CF2)y)n); PFA, a copolymer of tetrafluoroethylene and a perfluorinated vinyl ether (((CF(ORf)-CF2)x(CF2-CF2)y)n); MFA, a random copolymer of tetrafluoroethylene and perfluoromethylvinylether; ETFE (Styrene), a copolymer of primarily ethylene and tetrafluoroethylene (((CF2-CF2)x-(CH2-CH2)y)n); ECTFE, a copolymer of ethylene and chlorotrifluoroethylene (((CH2-CH2)x-(CFCl—CF2)y)n); PVdF, a homopolymer of vinylidene fluoride ((CH2-CF2)n); and THV, a terpolymer of tetrafluoroethylene, hexafluoropropylene, and vinylidene fluoride ((CF(CF3)-CF2)x(CF2-CF2)V(CF2-CF2)z)n).

Polysilicates may be attractive to include in any of the plates. For example, during consumption of a fuel pack, the vaporization of a plate containing a polysilicate may provide for a chemical reaction to generate desirable by-products, which then in some cases may themselves be consumed. One polysilicate is silicon dioxide (SiO2) or sand, which when vaporized with a plastic dielectric will generate a by-product from the family of ethers. As ethers are highly volatile, an ether by-product will contribute to the fuel pack consumption through combustion. Other by-products may tie up oxygen molecules to prevent harmful combinations with oxygen, such as nitrogen-oxygen and carbon-oxygen combinations.

Many other chemical reactions may be designed to produce various by-products. For one example out of many, oxygen-deficient boron suboxides may be included in plates of the fuel pack such that consumption of the fuel pack causes a boron suboxide (B60) by-product.

Thus, an effective fuel pack may be constructed, just as one example, of aluminum plates alternated with Teflon plates and including periodic cupric oxide plates.

An exemplary material for use in an ignitor is tungsten, or other material able to withstand high temperature and pressure. The ignitor may be included with the fuel pack or may be provided separately.

### Exemplary Energy Generation System—Power Grid Supply

In an exemplary energy generation system used to supply energy to a power grid, large fuel packs or multiple fuel packs may be loaded into a fuel pack receptacle and ignited. Ignition may be in parallel, or may be serial such that the sublimation of the last plate of one fuel pack acts as the ignitor for the next fuel pack.

The energy produced by the consumption of the fuel pack is directed to a large tank of water, for example. The water is separate from the energy generation system with a membrane that holds the water inside the tank. The shock wave of energy travels at supersonic or hypersonic speeds, with extreme pressure up to the millions of atmospheres, and to temperatures in the thousands of degrees Celsius. When the shock wave hits the water through the membrane, the water is vaporized into steam. The steam may be used to turn turbine blades for electricity generation.

Because a vast amount of energy is applied to the water, a vast amount of steam is produced and therefore a vast amount of electrical energy may be produced and added to the power grid.

When the power grid requires another influx of energy, the process is repeated.

### Exemplary Energy Generation System—Building Supply

The process described above for power grid energy generation may be scaled down and used to power industrial sites, apartment buildings, individual homes, and the like. For example, a home may include a fuel receptacle into which is loaded a small fuel pack. The small fuel pack may be detonated, and the energy from the subsequent consumption of the fuel pack may be used, for example, to generate steam, or to directly cause a turbine to turn. For another example, the energy produced may be used to heat a material to a point below vaporization and the heat then stored or immediately used in a thermal gradient energy conversion process such as in a heat engine.

### Exemplary Energy Generation System—Destruction

The high-yield energy generation system produces an extremely high-pressure high-speed shock front or shock waves. The shock front or waves, when directed onto an object, will be destructive. Depending on the amount of energy generated and the mass of the object receiving the shock, the object may sublimate. Thus, the energy generation system may be used, for example, in demolition, quarrying, mining, and the like.

Further, the angle of incidence of the shock front or waves may be adjusted to remove only portions of an object. For example, the energy generation system may be used in excavation and other ground shaping, or to accomplish partial demolition.

### Exemplary Energy Generation System—Drilling

The generated energy may be focused into an extreme high pressure, small diameter beam, for example using a Venturi-type structure to gradually narrow the energy output path to a desired output aperture size and shape. The high pressure narrow beam may be directed towards the earth. The hypersonic energy shock front may sublimate the earth in the path of the narrow beam, creating a shaft. The high temperature of the energy front may seal the walls of the shaft to prevent the shaft from collapsing. Repeated shocks would dig the shaft deeper. Such a shaft could be used for a well if wide enough, or as a pilot shaft.

Drilling could also be performed underwater and controlled remotely.

A secure blow-out prevention device may further be placed over a drill site for use in close areas or where combustible materials are present.

### Exemplary Energy Generation System—Geomapping, Prospecting

The generated energy may be directed towards the earth at a desired angle of incidence and the echos from the delivered energy front used to map the internal structure of the earth in the area. In this manner, underground caves may be identified before beginning a construction project, oil reservoirs may be identified without the expense of exploratory drilling, tectonic plates may be studied, and geological history may be determined, to name just a few possibilities.

Additionally, the generated energy may be directed through large bodies of water and the echoes used to determine depth, temperature, structure of the floor, and the like.

### Exemplary Energy Generation System—Propulsion

An energy generation system as described may be used in a propulsion system. In one implementation, a fuel pack may be consumed, the energy stored, and the stored energy used to propel the vehicle for a length of time. For example, a person may load a small fuel pack into a fuel receptacle in the car, detonate the fuel pack, and then drive all day on the energy stored from the energy generation process.

In another implantation, a set of fuel packs may be detonated in series to provide near continuous energy output. For example, multiple small fuel packs may be detonated in sequence to launch a space vehicle out of earth orbit, and then small fuel packs may be used to adjust the pitch, roll, and yaw of the vehicle in space. Because the energy generation process does not rely on burning the fuel, oxygen is not necessary.

Similarly, the described energy generation process may be used for underwater propulsion.

### Exemplary Energy Generation System—Distance Communication

An energy generation system may control detonation of multiple very small fuel packs or individual plates and focus the generated energy into a narrow beam. The detonation may be controlled in such a manner that each detonation represents, for example, a bit in a data stream. The data stream would travel long distances before becoming corrupted and could therefore be used, as one example, for earth to space communication.

### Exemplary Energy Generation System—Military/police Applications

Generated energy may be directed at structures with the aim of destruction, as discussed above. For example, the energy may be used for the destruction of military targets such as weapons depots or bridges. Further, generated energy may be used to disable or destroy ground or air vehicles.

Generated energy may be directed towards radio towers or communications centers or the like to disable communications equipment with the high energy.

Generated energy may further be used to propel projectiles to targeted locations.

### Exemplary Energy Generation System—Home Use

A scaled-down energy generation system may be used in the home environment. In one implementation, a fuel pack may be consumed in the system and used to heat a reservoir of liquid. The liquid may be circulated to provide heat for the house or may be used to heat water for use in the house. The liquid may be water that is stored in a tank for household use.

The energy generation system may be used to heat the water in a pool. Generated energy may be stored and used for thermal gradient energy conversion, such as conversion to mechanical or electrical energy through a heat engine.

### Exemplary Energy Generation System—Particle Acceleration

The energy generation system may be used to replace the accelerator in an “atom-smasher”. The generated energy may be used to propel elementary particles for collision with other particles or with sheets or blocks of materials. For example, a fuel pack may include one or more sheets of zinc. When the zinc sheets sublimate, the particle cloud that forms may be propelled at hypersonic speeds towards a sheet of lead to create atoms of new element 112. Other elements may also be formed in similar manner.

### Exemplary Energy Generation System—Smokestack Scrubber

The energy generation system may be used as a smokestack scrubber or in addition to a smokestack scrubber to reduce particulates at the smokestack output.

The energy generation system may be used to increase the temperature in the smokestack to prevent compounds such as carbon dioxide and sulfur dioxide from forming within the smokestack. Additionally, the composition of the fuel stack plates may be selected to deplete the amount of free oxygen available for the formation of compounds.

Thus has been described a high-efficiency, high-yield energy generation system that uses detonation followed by sublimation to consume a stacked plate fuel pack including metal plates as a fuel source. Such a high-efficiency, high-yield energy generation system may be constructed for use in many applications, including for supplying power grids, for powering large buildings, for destruction, for drilling, for mining, for propulsion, for long-distance communication, for military and police uses, for home use, and for particle acceleration, to name just a few.

Research indicates ninety-eight percent (98%) efficiency for the described energy generation process. When efficiency costs and fuel costs are compared between a petrochemical energy generation system and an aluminum-based high-efficiency energy generation system, the aluminum-based high-efficiency energy generation system costs reach as low as approximately one percent (1%) of traditional petrochemical energy generation systems costs.

The descriptions of processes herein are provided for the purpose of illustration, and should in no way be construed so as to limit the claimed invention.

Accordingly, it is to be understood that the above description is intended to be illustrative and not restrictive. Many implementations and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A stacked plate fuel pack, comprising:
at least two of a first type of plate in which the composition of the plates includes a metal; and
at least one of a second type of plate; wherein the at least one of a second type of plate is disposed between the at least two of the first type of plate.

2. The stacked plate fuel pack of claim 1, further comprising:
a first wire, the first wire electrically attached to a first one of the first type of plate; and
a second wire, the second wire electrically attached to a second one of the first type of plate;
wherein, when the first wire is electrically connected to a positive terminal of a power source and the second wire is electrically connected to a negative terminal of the power source, the first one of the first type of plate and the second one of the first type of plate together form a capacitor.

3. The stacked plate fuel pack of claim 1, the composition of the second type of plate being the same as the composition of the first type of plate.

4. The stacked plate fuel pack of claim 1, the stacked plates rolled into a cylindrical shape.

5. The stacked plate fuel pack of claim 1, the metal being aluminum.

6. The stacked plate fuel pack of claim 5, the composition of the first type of plate including polytetrafluoroethylene (also known as PTFE or Teflon).

7. The stacked plate fuel pack of claim 6, at least one plate of the first type formed of a compressed mixture of aluminum and Teflon particles.

8. The stacked plate fuel pack of claim 5, the composition of the second type of plate including polytetrafluoroethylene (also known as PTFE or Teflon).

9. The stacked plate fuel pack of claim 5, the composition of at least one of the first type of plate including a polysilicate.

10. The stacked plate fuel pack of claim 9, the polysilicate being sand.

11. The stacked plate fuel pack of claim 5, the composition of at least one of the second type of plate including a polysilicate.

12. The stacked plate fuel pack of claim 11, the polysilicate being sand.

13. The stacked plate fuel pack of claim 1, the composition of the second type of plate having dielectric properties.

14. The stacked plate fuel pack of claim 1, the composition of the second type of plate having properties of an accelerant.

15. The stacked plate fuel pack of claim 14, the composition of the second type of plate further having dielectric properties.

16. The stacked plate fuel pack of claim 1, the first plate of the stacked plate fuel pack designed to sublimate at the occurrence of a detonation event.

17. They stacked plate fuel pack of claim 16, the fuel pack designed such that energy generated from sublimation of the first plate impacts an adjacent plate and causes the adjacent plate to sublimate.

18. A system, comprising:
a fuel pack receptacle configured to hold at least one stacked plate fuel pack;
a preheater; and
an ignitor configured to generate a detonation event within the fuel pack receptacle.

19. The system of claim 18, further comprising a stacked plate fuel pack loaded into the fuel pack receptacle.

20. The system of claim 19, the preheater configured to heat at least one plate of the stacked plate fuel pack.

21. The system of claim 19, the ignitor configured to generate the detonation event adjacent to a first plate of the stacked plate fuel pack.

22. The system of claim 21, the first plate of the stacked plate fuel pack designed to sublimate when the ignitor generates the detonation event.

23. The system of claim 18, further comprising an energy focus mechanism configured to focus energy generated by consumption of a fuel pack loaded into the fuel pack receptacle.

24. The system of claim 23, the energy focus mechanism configured to increase the pressure of energy generated by the system.

25. A method, comprising:
preheating plates in a stacked plate fuel pack;
creating a detonation event adjacent to a first plate of the stacked plate fuel pack, thereby causing the first plate to sublimate; and
focusing energy generated by sublimation of the first plate of the stacked plate fuel pack.

26. The method of claim 25, the preheating comprising
providing an electrical current through a closed circuit including: a source; a first wire connected to a positive terminal of the source and further connected to one of the plates of the stacked plate fuel pack; and a second wire connected to another of the plates of the stacked plate fuel pack and further connected to the negative terminal of the source.
